(19) United States
(12) Patent Application Publication
(10) Pub. No.: US 2022/0228848 A1
(43) Pub. Date: Jul. 21, 2022

(54) PROFILE STRAND FOR ERECTING CARRIER DEVICES

(71) Applicant: CARL ZEISS FIXTURE SYSTEMS GMBH, Tholey (DE)

(72) Inventors: Stephan KIRSCH, Riegelsberg (DE); Andreas STEGEMANN, Eppelborn (DE)

(21) Appl. No.: 17/609,473

(22) PCT Filed: Mar. 16, 2020
(86) PCT No.: PCT/DE2020/100198

§ 371 Date: Nov. 8, 2021

(30) Foreign Application Priority Data
May 7, 2019 (DE) 10 2019 111 807.7
Jun. 7, 2019 (DE) 10 2019 115 548.7

(51) Int. Cl. G01B 5/00

(52) U.S. Cl. CPC G01B 5/0004

(57) ABSTRACT

A profile strand for erecting carrier devices for holding in a reference position vehicle body components which are to be measured, including longitudinal side surfaces which adjoin one another at right angles and each have at least one undercut groove which runs in the longitudinal direction of the strand. The profile strand has at least one cylindrical core which, with attachments which protrude radially from the core and each form a section of a longitudinal side surface, forms a profile base module.

The invention relates to a profile strand for erecting carrier devices for mounting in a reference position body components to be measured, the latter having longitudinal lateral faces adjoining one another at right angles and having in each case at least one undercut groove that runs in the longitudinal direction of the strand.

Profile strands of this type are known from practical use. In order for dimensionally accurate mounting frames to be constructed, optionally for receiving a complete vehicle body, the profile strands can be connected to one another on a longitudinal side and an end side, wherein screw-fitting by way of slot nuts disposed in the undercut grooves takes place. Contacting elements and clamping elements for fixing the components can be comfortably fastened to a mounting frame formed by the profile strands.

Achieved by the invention is a new profile strand of the type mentioned at the outset, said new profile strand by way of at least one cylindrical core which, conjointly with attachment pieces that protrude radially from the core and in each case form a portion of a longitudinal lateral face, forms a profile base module.

The design embodiment according to the invention advantageously imparts great stability to the profile strand. The cylindrical core can in particular form a material accumulation that, apart from generally reinforcing the strand, enables particularly stable screw connections between strands and other components.

The cylindrical core, which can for example be configured so as to be circular-cylindrical or square in the cross section, for screw connections or alignment pins expediently has bores that extend parallel to the cylinder axis. A central bore which may be surrounded by further bores is in particular provided, the axes of said further bores lying on a cylinder shell surface that is coaxial with the central bore.

In one embodiment of the invention the attachment pieces comprise attachment pieces that are mushroom-shaped and optionally semi-mushroom-shaped in the cross section.

The attachment pieces are preferably configured so as to be hollow and have in particular a cavity that extends into the cylindrical core. The cavities advantageously reduce the weight of the profile strand in a significant manner.

The attachment pieces that are mushroom-shaped in the cross section can in each case form a corner of the cross-sectional profile.

The profile strand can have a profile base module, or in a further preferred embodiment is assembled from two or four profile base modules.

In the case of a plurality of profile base modules, the latter are connected to one another by way of semi-mushroom-shaped attachment pieces.

A half-bore for receiving cylindrical connecting pins can in each case be formed in the cavities of the mushroom-shaped attachment pieces.

The invention is further explained hereunder by means of exemplary embodiments and the appended drawings referring to these exemplary embodiments. In the drawings:

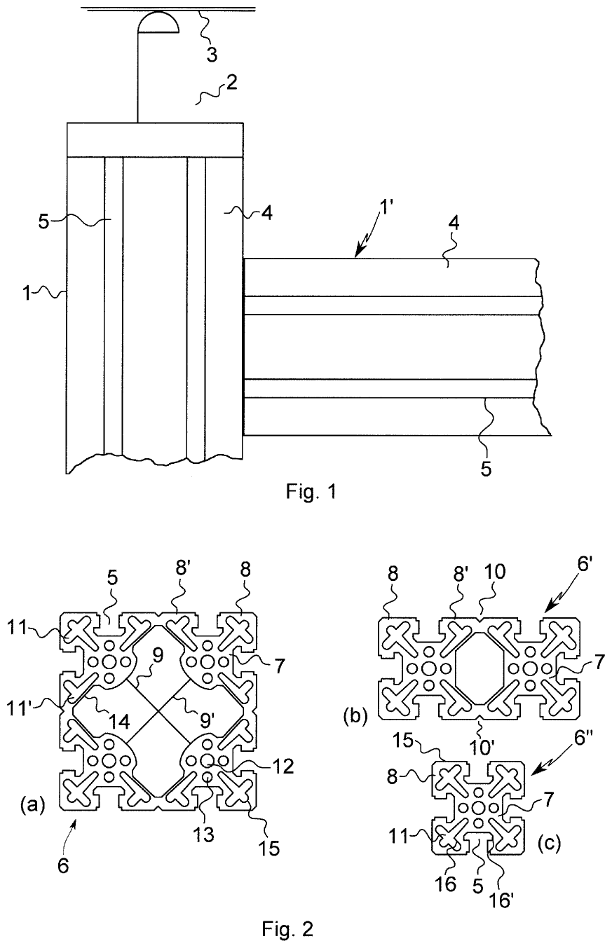

FIG. 1 shows a partial illustration of a mounting for a body component, said mounting being erected using profile strands according to the invention; and

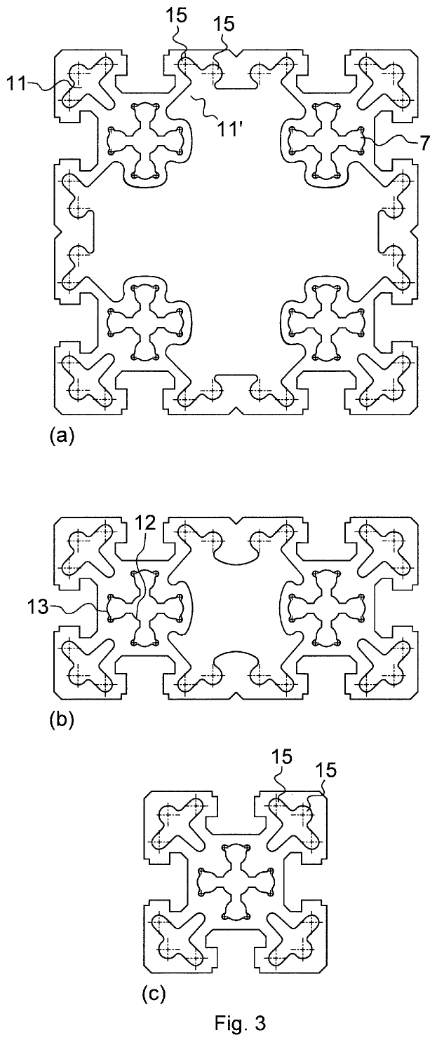

FIGS. 2 and 3 show different embodiments of cross sections of profile strands according to the invention.

A device for mounting a body component 3 to be measured, partially illustrated in FIG. 1, comprises profile strands 1 and 1′ having a cross-sectional area according to FIG. 2a.

The profile strand 1 at the end side shown in FIG. 1 is connected to a carrier head 2 which bears on the body component 3. The mounting device has a multiplicity of such or similar carrier heads for receiving the vehicle component 3.

The profile strand 1′ by way of the end side visible in FIG. 1 is connected to one of the longitudinal lateral faces 4 of the profile strand 1. Two undercut grooves 5 are formed in each of the four longitudinal lateral faces 4 of the profile strands 1, 1′.

As can be seen in FIG. 2a, the profile strands 1, 1′ are in each case assembled from four profile base modules 6 having a cylindrical core 7. Attachment pieces 8 and 8′ for forming portions of the longitudinal lateral walls 4 protrude from each cylindrical core 7.

The attachment pieces 8 of the four cylindrical cores 7 are configured so as to be mushroom-shaped and form in each case a corner of the profile strand 1 or 1′, respectively, while the attachment pieces 8′ that have the cross-sectional shape of half a mushroom form only a portion of a longitudinal lateral face 4. The profile base modules 6 are connected to one another by way of the attachment pieces 8′.

As is further shown in FIG. 2a, the four cylindrical cores 7 are connected to one another by way of intersecting web walls 9, 9′.

FIG. 2b shows a profile strand from two base modules 6′ having in each case a cylindrical core 7, two mushroom-shaped attachment pieces 8 and two attachment pieces 8′ configured as semi-mushrooms projecting in each case from said cylindrical core 7. The base modules are connected to one another at 10 and 10′ via the semi-mushroom-shaped attachment pieces. The exemplary embodiment of FIG. 2c consists only of a single profile base module 6″, from the cylindrical core 7 of which there extend four mushroom-shaped attachment pieces 8 which in each case form a corner of the profile strand.

The attachment pieces 8, as well as the attachment pieces 8′ that form approximately half of the mushroom-shaped attachment piece 8, are hollow and configured having a cavity 11 or 11′, respectively, that extends into the respective cylindrical core 7, wherein the cavities 11′ are in each case closed off by a web wall 14.

The cylindrical cores 7 which can be configured so as to be circular-cylindrical or square in the cross section, for example, form a material accumulation and have bores that are parallel to the cylinder axis, wherein a central bore 12 and further bores 13 that surround the central bore are formed in the example.

A half-bore for receiving cylindrical pins is in each case formed at 15 in the cavities 11 of the mushroom-shaped attachment pieces 8.

Such half-bores could also be formed in the undercut region of the grooves 5, at 16 and 16′, for example.

It is understood that the bores 12, 13 and half-bores 15, 16 and 16′ can be utilized for establishing screw and pin connections between profile strands, such as the profile strands 1 and 1′ shown in FIG. 1, as well as for connecting to mounting parts such as the carrier head 2 shown in FIG. 1.

Slot nuts which engage in the grooves 5 can serve as a connection between the profile strands 1 and 1′. The profile strand 1 by way of slot nuts could also be connected to an adapter which is able to be screwed to the end side of the profile strand 1 and projects beyond that end side of the profile strand 1′ that faces the profile strand 1 such that screws which can be connected to the slot nuts are comfortably accessible.

An exemplary embodiment of a profile strand shown in FIG. 3 differs from the exemplary embodiment according to FIG. 2 in that the central bore 12 incorporated in the core 7 in spatial terms is connected to the bores 13 surrounding the bore 12. Furthermore, the web walls 9, 9′ and 14 are missing. The cavities 11, 11′ have in each case more than one half-bore 15. A further difference in comparison to the exemplary embodiment of FIG. 2 lies in that the bores 13 are axially slotted.

The profile strand shown in FIGS. 2a and 3a has cross-sectional dimensions of 100×100 mm, the profile strand of FIGS. 2b and 3b has cross-sectional dimensions of 100×50 mm, and the profile strand according to FIGS. 2c and 3c has cross-sectional dimensions of 50×50 mm.

1-10. (canceled)

11. A profile strand for erecting a carrier device for mounting body components to be measured in a reference position, comprising: longitudinal lateral faces adjoining one another at right angles and having in each case at least one undercut groove that runs in a longitudinal direction of the strand; and at least one cylindrical core which, conjointly with attachment pieces that protrude radially from the core and in each case form a portion of one of the longitudinal lateral faces, forms a profile base module.

12. The profile strand according to claim 11, wherein the cylindrical core is a material accumulation.

13. The profile strand according to claim 11, wherein the cylindrical core is configured to have a circular-cylindrical cross section or a square cross section.

14. The profile strand according to claim 11, wherein the cylindrical core has bores that extend parallel to a cylinder axis.

15. The profile strand according to claim 14, wherein the bores include a central bore.

16. The profile strand according to claim 11, wherein the attachment pieces include attachment pieces that are mushroom-shaped in cross section.

17. The profile strand according to claim 16, wherein the attachment pieces include attachment pieces that are semi-mushroom-shaped in cross section.

18. The profile strand according to claim 11, wherein the attachment pieces are configured so as to be hollow.

19. The profile strand according to claim 18, wherein the attachment pieces have a cavity that extends into the cylindrical core.

20. The profile strand according to claim 16, wherein the attachment pieces that are mushroom-shaped in the cross section form in each case a corner of the profile strand.

21. The profile strand according to claim 11, wherein the profile strand is assembled from two or four profile base modules.

22. The profile strand according to claim 17, wherein a plurality of profile base modules are connected to one another by the semi-mushroom-shaped attachment pieces.

23. The profile strand according to claim 19, wherein at least one half-bore for receiving a cylindrical connecting pin is formed in each of the cavities of the mushroom-shaped attachment pieces.
